(19) United States
(12) Patent Application Publication
(10) Pub. No.: US 2024/0417830 A1
(43) Pub. Date: Dec. 19, 2024

(54) NON-ORIENTED SILICON STEEL FOR DRIVING MOTORS OF NEW ENERGY VEHICLES AND PRODUCTION METHOD THEREOF

(71) Applicants: INSTITUTE OF RESEARCH OF IRON AND STEEL, JIANGSU PROVINCE/SHA-STEEL, CO. LTD (CN), Suzhou, Jiangsu (CN); Jiangsu Shagang Group Co., Ltd., Suzhou, Jiangsu (CN); ZHANGJIAGANG YANGTZE RIVER COLD ROLLED PLATE CO., LTD, Suzhou, Jiangsu (CN)

(72) Inventors: Chongxiang YUE, Suzhou, Jiangsu (CN); Hongwei QIAN, Suzhou, Jiangsu (CN); Shengjie WU, Suzhou, Jiangsu (CN); Dongfang ZHAN, Suzhou, Jiangsu (CN)

(21) Appl. No.: 18/703,948

(22) PCT Filed: Jan. 27, 2022
(86) PCT No.: PCT/CN2022/074302

§ 371 Date: Apr. 23, 2024

(30) Foreign Application Priority Data
Oct. 26, 2021 (CN) 202111244023.3

(51) Int. Cl. C22C 38/02; C21D 1/26; C21D 6/00; C21D 8/10; C21D 8/12; C21D 9/46; C22C 33/04; C22C 38/00; C22C 38/04; C22C 38/06

(52) U.S. Cl. CPC C22C 38/02; C21D 1/26; C21D 6/008; C21D 8/105; C21D 8/1222; C21D 8/1233; C21D 8/1261; C21D 8/1272; C21D 8/1277; C21D 9/46; C22C 33/04; C22C 38/008; C22C 38/04; C22C 38/06

(57) ABSTRACT

A non-oriented silicon steel for driving motors of new energy vehicles and a production method thereof. The silicon steel is produced sequentially by steel smelting, continuous casting, hot rolling, normalizing, acid washing, single stand cold rolling without pre-heating, annealing, cooling, coating, and finishing. During steel smelting, no Cu, Cr, Ni, Nb, V, and Ti are added. The silicon steel comprises the following chemical ingredients: Si: 2.95%-3.15%, Al: 0.75%-0.95%, Si+2Al: 4.6%-4.9%, Mn: 0.5%-0.7%, Sn: 0.03%-0.04%, C≤0.0025%, with the balance being iron, wherein Mn/S≥380, and Al/N≥200. In the present application, the strength is improved while the magnetic performance is ensured, to solve the problem in the prior art that the magnetic performance and strength cannot be pursued at the same time, thus meeting the requirements for use in driving motors of new energy vehicles.

### TECHNICAL FIELD

The present application relates to the technical field of steel material preparation technologies, and particularly to a non-oriented silicon steel for driving motors of new energy vehicles and a production method thereof.

### BACKGROUND

Non-oriented silicon steel is an iron core material for motors and generator rotors working in rotating magnetic fields, which requires good magnetic performances, including low iron loss and high magnetic induction intensity. The improvement of magnetic performances is always a core research subject of non-oriented silicon steel by skilled technicians in the art. Generally, in terms of the chemical composition, the addition of a series of alloying elements such as Cu, Cr, Ni, Nb, V, Ti and others is strictly restricted, to avoid the deterioration of the magnetic performances of non-oriented silicon steel due to the high content of these alloying elements.

With the rapid development of new energy vehicles in recent years, higher performance requirements are put forward for non-oriented silicon steel for use in driving motors. Particularly, compared with other conventional motors, the driving motor of new energy vehicle has high rotational speed, and with the development of technology, the rotational speed of the driving motor of new energy vehicles is still increasing, requiring that the non-oriented silicon steel used should have high strength in addition to good magnetic performances.

However, in the prior art, the improvement of the strength of steel generally requires increased contents of a series of alloying elements such as Cu, Cr, Ni, Nb, V, Ti and others added in the chemical composition, to achieve the purpose of improving the strength of steel. Combined with the above, it can be seen that the increase of these alloying elements will deteriorate the magnetic performances of non-oriented silicon steel.

It can be seen that the design directions of chemical composition are contradictory in aspects of the magnetic performance and strength of non-oriented silicon steel. Therefore, how to ensure the magnetic performances and strength of non-oriented silicon steel at the same time is an important problem for non-oriented silicon steel for use in the driving motor of new energy vehicles.

### SUMMARY

An object of the present application is to provide a non-oriented silicon steel for driving motors of new energy vehicles and a production method thereof. In the present application, the strength is improved while the magnetic performance is ensured, to solve the problem in the prior art that the magnetic performance and strength cannot be pursued at the same time.

To achieve the above object of the present application, an embodiment of the present application provides a non-oriented silicon steel for driving motors of new energy vehicles, which has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, and C+S+N≤0.007%, with the balance being Fe and inevitable impurities, where Mn/S≥380, and Al/N≥200.

Further, the recrystallized grain size of the non-oriented silicon steel is 50 μm-80 m.

Further, the non-oriented silicon steel is a steel plate with a thickness of 0.25 mm to 0.35 mm, a yield strength of ≥460 Mpa, a tensile strength of ≥550 Mpa, an iron loss P_{1.0/400} of ≤18.5 W/kg, and a magnetic induction strength B₅₀₀₀ of ≥1.67 T.

Further, the non-oriented silicon steel is a steel plate with a thickness of 0.25 mm and an iron loss P₁0.0/400 of ≤17.5 W/kg; a steel plate with a thickness of 0.30 mm and an iron loss P_{1.0/400} of ≤18.0 W/kg; or a steel plate with a thickness of 0.35 mm and an iron loss P_{1.0/400} of ≤18.5 W/kg.

To achieve the above object of the present application, an embodiment of the present application provides a method for producing a non-oriented silicon steel for driving motors of new energy vehicles. The non-oriented silicon steel has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, and C+S+N≤0.007%, with the balance being Fe and inevitable impurities, where Mn/S≥380, and Al/N≥200.

The recrystallized grain size of the non-oriented silicon steel is 50 μm-80 m.

The production method includes, sequentially, steel smelting, continuous casting, hot rolling, normalizing, acid washing, single stand cold rolling, annealing, cooling, coating, and finishing, to produce the non-oriented silicon steel.

In the hot rolling procedure, a continuously casted billet obtained after the continuous casting procedure is heated to 1080° C.-1110° C. for 160 min-180 min, followed by rough rolling, finish rolling, and cooling sequentially, to obtain a hot-rolled coiled plate. During the finish rolling, the rolling start temperature is 950±20° C., the rolling end temperature is 840±20° C., and the total rolling reduction rate is 94-95%. During the coiling, the coiling temperature is 620±20° C.

In the normalizing procedure, the normalizing temperature is 840° C.-860° C. for 180s-200s.

In the annealing procedure, the annealing temperature is 960° C.-980° C. for 40 s−45 s.

Preferably, in the single stand cold rolling procedure, multi-pass rolling is carried out, the total rolling reduction rate is 85±3%, and the rolling reduction rates of other passes except the last pass are not less than 30%.

Preferably, the obtained non-oriented silicon steel is a steel plate with a thickness of 0.25 mm to 0.35 mm. In the hot rolling procedure, the continuously casted billet with a thickness of 220 mm is rough rolled into an intermediate billet with a thickness of 35 mm-40 mm, and then finish rolled into a hot-rolled plate with a thickness of 2.00 mm-2.30 mm.

Preferably, the obtained non-oriented silicon steel is a steel plate with a thickness of 0.25 mm, the intermediate billet has a thickness of 35 mm, and the hot-rolled plate has a thickness of 2.00 mm. Alternatively, the obtained non-oriented silicon steel is a steel plate with a thickness of 0.30 mm, the intermediate billet has a thickness of 37.5 mm, and the hot-rolled plate has a thickness of 2.15 mm. Alternatively, the obtained non-oriented silicon steel is a steel plate with a thickness of 0.35 mm, the intermediate billet has a thickness of 40 mm, and the hot-rolled plate has a thickness of 2.30 mm.

Preferably, in the single stand cold rolling procedure, the steel plate after the acid washing procedure is directly rolled without preheating.

Compared with related art, the present application has the following beneficial effects.
(1) In terms of the chemical composition, no alloying materials of Cu, Cr, Ni, Nb, V, Ti are added, which, in combination with the content design of elements of Si, Al, Mn, Sn, improves the magnetic performances of the non-oriented silicon steel and ensures that the non-oriented silicon steel has lower iron loss and higher magnetic induction intensity. Meanwhile, on the basis of the chemical composition, by controlling the grain size between 50 m and 80 m, the fine grain strengthening of the steel plate is realized, to ensure that the non-oriented silicon steel has high strength. In this way, the comprehensive optimization of the magnetic performances and strength of the non-oriented silicon steel can be realized with low cost and low production difficulty, so that the non-oriented silicon steel can meet the requirements for use in driving motors of new energy vehicles.
(2) Further, on the basis of the chemical composition design, by controlling a series of processes including the hot rolling procedure, the normalizing procedure, the single stand cold rolling procedure, and the annealing procedure, the fining of the recrystallized grain size of the non-oriented silicon steel is realized, to obtain a non-oriented silicon steel having excellent magnetic performances and high strength; the problem of crack and fracture in cold rolling is avoided and the pre-rolling heating and the secondary cold rolling in the existing production process are omitted, so that the final rolling can be implemented by the single stand cold rolling procedure without preheating, and the low difficulty, low cost, stability and continuity of the production are ensured. Moreover, by the lower temperature control of the heating temperature, the rolling start temperature and the normalizing temperature, the energy consumption during production can be greatly reduced. In addition, the normalizing temperature is low and the holding time is short, which can also reduce the thickness of the iron oxide scale on the surface of the steel plate before the acid washing process, thus improving the acid washing efficiency and improving the surface quality and yield of the final non-oriented silicon steel.

### DETAILED DESCRIPTION OF EMBODIMENTS

Hereinafter, the technical solutions of the present application will be further described with reference to specific embodiments.

An embodiment of the present application provides a non-oriented silicon steel. The non-oriented silicon steel has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, and C+S+N≤0.007%, with the balance being Fe and inevitable impurities, where Mn/S≥380, and Al/N≥200.

The functions and effects of each element in the chemical composition are described as follows.

C, S, N, Cu, Cr, Ni, Nb, V, Ti, and P: The elevated contents of these elements will deteriorate the magnetic performances of the non-oriented silicon steel, including increased iron loss, and decreased magnetic induction intensity. In the present application, the upper limit of the content of these elements is appropriately reduced provided that the difficulty and cost of steel smelting are not increased, where C≤0.0025%, S≤0.0015%, N≤0.004%, C+S+N≤0.007%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, and P≤0.015%.

Si and Al: Si is a solid solution strengthening element, and the elevated content will increase the strength of the steel plate, and also increase the resistivity and reduce the iron loss of the steel plate. In the present application, the Si content (in percentages by weight) is controlled to 2.95%-3.15%. The elevated content of Al will increase the resistivity and reduce the iron loss of the steel plate, but it will also reduce the magnetic induction intensity. In the present application, the Al content (in percentages by weight) is controlled to 0.75%-0.95%. Moreover, Al and N tend to form a coarse AlN precipitate, which reduces the iron loss of the steel plate. In the present application, the Al content (in percentages by weight) and the N content (in percentages by weight) further meet Al/N≥200. As a result, the adverse effect of N element on the magnetic performances of the steel plate can be fully converted into a beneficial effect, and the difficulty of controlling N element in steel smelting is reduced. In addition, the elevated contents of Si and Al will also lead to the difficulty in cold rolling. To avoid the increase of the production cost caused by the increase of the production difficulty, the Si content (in percentages by weight) and the Al content (in percentages by weight) further meet Si+2Al:4.6%-4.9%.

Mn: The addition of an appropriate amount of Mn is beneficial to the improvement of the magnetic performances of the steel plate. Moreover, Mn can inhibit the hot brittleness caused by S, and tends to form a coarse MnS precipitate with S, thus reducing the iron loss of the steel plate. In the present application, the Mn content (in percentages by weight) and the S content (in percentages by weight) further meet Mn/S≥380. As a result, the adverse effect of S element on the magnetic performances of the steel plate can be fully converted into a beneficial effect, and the difficulty and cost of controlling S element in steel smelting are reduced.

Sn: Sn is a grain boundary segregating element, which can improve the magnetic performances. The Sn content (in percentages by weight) in the present application is 0.03%-0.04%.

As mentioned above, in terms of the chemical composition in this embodiment, while low alloying cost, low production difficulty, and low production cost are ensured, no alloying elements of Cu, Cr, Ni, Nb, V, Ti are added, which, in combination with the content design of the elements of Si, Al, Mn, Sn, improves the magnetic performances of the non-oriented silicon steel and ensures that the non-oriented silicon steel has lower iron loss and higher magnetic induction intensity.

Moreover, in this embodiment, the recrystallized grain size of the non-oriented silicon steel is 50 μm-80 μm. In this way, while the non-oriented silicon steel is ensured to have low iron loss and high magnetic induction intensity by the above chemical composition, by controlling the grain size between 50 m and 80 m, the fine grain strengthening of the steel plate is realized, to ensure that the non-oriented silicon steel has high strength. Therefore, the comprehensive optimization of the magnetic performances and strength of the non-oriented silicon steel can be realized with low cost and low production difficulty, so that the non-oriented silicon steel can meet the requirements for use in driving motors of new energy vehicles.

Particularly, the non-oriented silicon steel is a steel plate with a thickness of 0.25 mm to 0.35 mm, a yield strength of ≥460 Mpa, a tensile strength of ≥550 Mpa, an iron loss P₁0.0/400 of ≤18.5 W/kg, and a magnetic induction strength B₅₀₀₀ of ≥1.67 T.

Further, the non-oriented silicon steel is specifically a steel plate with a thickness of 0.35 mm and an iron loss P_{1.0/400} of ≤18.5 W/kg; a steel plate with a thickness of 0.30 mm and an iron loss P_{1.0/400} of ≤18.0 W/kg; or a steel plate with a thickness of 0.25 mm and an iron loss P_{1.0/400} of ≤17.5 W/kg.

Further, an embodiment of the present application further provides a preferred method for producing the non-oriented silicon steel. The production method includes, sequentially, steel smelting, continuous casting, hot rolling, normalizing, acid washing, single stand cold rolling, annealing, cooling, coating, and finishing to produce the non-oriented silicon steel. That is, the non-oriented silicon steel can be produced by the preferred production method. The production method of this embodiment not only can successfully produce the non-oriented silicon steel with excellent magnetic performances and high strength, but also has the advantages of low production difficulty, low production cost and the like, thus ensuring the stable production of non-oriented silicon steel.

Particularly, molten iron is refined into molten steel in the steel smelting process, and the molten steel obtained in the steel smelting process is made into a continuously casted billet by a continuous casting machine in the continuous casting procedure. It can be understood that the chemical composition of molten steel obtained in the steel smelting procedure and the chemical composition of the continuously casted billet obtained in the continuous casting procedure are consistent with the chemical composition of the non-oriented silicon steel finally obtained by the production method. That is, in percentages by weight, including Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, and C+S+N≤0.007%, with the balance being Fe and inevitable impurities, where Mn/S≥380, and Al/N≥200.

In this embodiment, in the hot rolling procedure, a continuously casted billet obtained after the continuous casting procedure is heated to 1080° C.-1110° C. for 160 min-180 min, followed by rough rolling, finish rolling, and cooling sequentially, to obtain a hot-rolled coiled plate. During the finish rolling, the rolling start temperature is 950±20° C., the rolling end temperature is 840±20° C., and the total rolling reduction is 94-95%. During the coiling, the coiling temperature is 620±20° C. In the normalizing procedure, the normalizing temperature is 840° C.-860° C. for 180s-200s. In the annealing procedure, the annealing temperature is 960° C.-980° C. for 40 s−45 s.

Accordingly, in the production method of this embodiment by controlling the lower heating temperature in the hot rolling procedure, the solid solution of coarse precipitates such as MnS and AlN in the continuously casted billet is avoided, so as to ensure the control of precipitates in the subsequent rough rolling and finish rolling processes, thus laying a foundation for the magnetic performances of the finally obtained non-oriented silicon steel. By controlling the rolling start temperature and rolling end temperature during the finish rolling process, the total rolling reduction rate and the coiling temperature during the coiling procedure, in combination with the design of Si+2Al:4.6%-4.9% in the chemical composition, the structure of the hot-rolled coiled plate is stable and the stored energy is consistent, This ensures the recrystallization temperature of the hot-rolled coiled plate to remain stable in the subsequent normalizing procedure, so as to create conditions for accurate control of the recrystallization degree in the subsequent normalizing procedure. On the basis of the hot rolling procedure, through the design of the normalizing temperature and the holding time in the normalizing process, partial recrystallization (that is, the recrystallization is not completely completed or complete recrystallization does not occur) occurs in the normalizing process, so that the area proportion of non-recrystallized structure and the recrystallized grain size in the obtained steel plate are accurately controlled. Specifically, the area proportion of the non-recrystallized structure is about 5%-20%, and the recrystallized grain size is ≤50 μm. This can create conditions for controlling the recrystallized grain size in the annealing procedure and avoid crack propagation in the subsequent cold rolling due to the presence of a large number of grain boundaries between the non-recrystallized structures and the recrystallized grains, so as to reduce the rolling difficulty of the cold rolling procedure and ensure the stable production of the cold rolling procedure. The pre-rolling heating and the secondary cold rolling in the prior art are omitted, so that the final rolling can be implemented by the low-cost single stand cold rolling procedure without preheating. Moreover, on the basis of the normalizing procedure, complete recrystallization occurs in the annealing procedure through the design of the annealing temperature and the holding time, while the recrystallized grains do not grow obviously, thus ensuring that the recrystallized grains in the final non-oriented silicon steel product are small in size.

Therefore, in the production method of this embodiment, on the basis of the chemical composition design, by controlling a series of processes including the hot rolling procedure, the normalizing procedure, the single stand cold rolling procedure, and the annealing procedure, the fining of the recrystallized grain size of the non-oriented silicon steel is realized, to obtain a non-oriented silicon steel having excellent magnetic performances and high strength; and the problem of crack and fracture in cold rolling is avoided and the pre-rolling heating and the secondary cold rolling in the existing production process are omitted, so that the final rolling can be implemented by the single stand cold rolling procedure without preheating, and the low difficulty, low cost, stability and continuity of the production are ensured. Moreover, by the lower temperature control of the heating temperature, the rolling start temperature and the normalizing temperature, the energy consumption during production can be greatly reduced. In addition, the normalizing temperature is low and the holding time is short, which can also reduce the thickness of the iron oxide scale on the surface of the steel plate before the acid washing process, thus improving the acid washing efficiency and improving the surface quality and yield of the final non-oriented silicon steel.

Further preferably, based on the chemical composition required by the final molten steel, no alloying materials of Cu, Cr, Ni, Nb, V, and Ti are added in the steel smelting procedure. This reduces the cost of the alloying materials.

Further preferably, in the single stand cold rolling procedure, the steel plate after the acid washing procedure is directly rolled without preheating. In the prior art, the steel plate is generally preheated before cold rolling. However, in this embodiment, on the basis of the normalizing procedure, rolling can be performed directly without preheating, thereby saving the production cost.

In the single stand cold rolling procedure, multi-pass rolling is carried out, and the total rolling reduction rate is 85±3%. As a result, the cold rolling energy storage in the single stand cold rolling procedure of non-oriented silicon steel having various thickness is basically the same, and the subsequent annealing process can be performed at the same annealing temperature for the same holding time, so as to achieve the effect of continuous production of non-oriented silicon steel with various thicknesses on the same production line without frequent operation changes.

Moreover, in the single stand cold rolling procedure, multi-pass rolling is carried out, the rolling reduction rates of other passes except the last pass are not less than 30%. For example 5-pass rolling is carried out, in which the rolling reduction rate of the 1st-4th passes is ≥30%, and the rolling reduction rate of the 5th pass is optionally less than 30%. In this way, the cold-rolling breakage occurring in the single stand cold rolling procedure is effectively avoided, the rolling passes are reduced, and the final non-oriented silicon steel is ensured to have a good plate shape.

As described above, the non-oriented silicon steel is a steel plate with a thickness of 0.25 mm to 0.35 mm. In a preferred embodiment, the continuously casted billet after the continuous casting procedure has a thickness of 220 mm. In the hot rolling procedure, the continuously casted billet with a thickness of 220 mm is rough rolled into an intermediate billet with a thickness of 35 mm-40 mm, and then finish rolled into a hot-rolled plate with a thickness of 2.00 mm-2.30 mm. It can be understood that in the single stand cold rolling procedure, the hot rolled plate with a thickness of 2.00 mm-2.30 mm is further rolled into a finished non-oriented silicon steel product with a target thickness.

For example, the non-oriented silicon steel finally obtained through the production method is a steel plate with a thickness of 0.25 mm. Then, in the hot rolling procedure, the continuously casted billet with a thickness of 220 mm is rough rolled into an intermediate billet with a thickness of 35 mm, and then finish rolled into a hot-rolled plate with a thickness of 2.00 mm. For example, the non-oriented silicon steel finally obtained through the production method is a steel plate with a thickness of 0.30 mm. Then, in the hot rolling procedure, the continuously casted billet with a thickness of 220 mm is rough rolled into an intermediate billet with a thickness of 37.5 mm, and then finish rolled into a hot-rolled plate with a thickness of 2.15 mm. For example, the non-oriented silicon steel finally obtained through the production method is a steel plate with a thickness of 0.35 mm. Then, in the hot rolling procedure, the continuously casted billet with a thickness of 220 mm is rough rolled into an intermediate billet with a thickness of 40 mm, and then finish rolled into a hot-rolled plate with a thickness of 2.30 mm. Definitely, these are merely preferred embodiments, and specific implementation of the present application is not limited thereto.

Preferably, in the normalizing procedure, the normalizing is carried out under pure and dry N₂ atmosphere, and the production speed is constant. That is to say, the roll speed is constant when normalizing is performed on the head middle, and tail of the steel plate.

Furthermore, in the annealing procedure, the annealing is carried out under a mixed atmosphere of H₂+N₂, and the production speed is constant. That is to say, the roll speed is constant when annealing is performed on the head middle, and tail of the steel plate.

In addition, in the production method, the acid washing procedure, the cooling procedure, the coating procedure and the finish rolling procedure are implemented by feasible techniques disclosed in the prior art, which will not be repeated here.

In summary, compared with related art, an embodiment of the present application has the following beneficial effects.
(1) In terms of the chemical composition, no alloying elements of Cu, Cr, Ni, Nb, V, Ti are added, which, in combination with the content design of the elements of Si, Al, Mn, Sn, improves the magnetic performances of the non-oriented silicon steel and ensures that the non-oriented silicon steel has lower iron loss and higher magnetic induction intensity. Meanwhile, on the basis of the chemical composition, by controlling the grain size between 50 m and 80 m, the fine grain strengthening of the steel plate is realized, to ensure that the non-oriented silicon steel has high strength. In this way, the comprehensive optimization of the magnetic performances and strength of the non-oriented silicon steel can be realized with low cost and low production difficulty, so that the non-oriented silicon steel can meet the requirements for use in driving motors of new energy vehicles.
(2) Further, on the basis of the chemical composition design, by controlling a series of processes including the hot rolling procedure, the normalizing procedure, the single stand cold rolling procedure, and the annealing procedure, the fining of the recrystallized grain size of the non-oriented silicon steel is realized, to obtain a non-oriented silicon steel having excellent magnetic performances and high strength; the problem of crack and fracture in cold rolling is avoided and the pre-rolling heating and the secondary cold rolling in the existing production process are omitted, so that the final rolling can be implemented by the single stand cold rolling procedure without preheating, and the low difficulty, low cost, stability and continuity of the production are ensured. Moreover, by the lower temperature control of the heating temperature, the rolling start temperature and the normalizing temperature, the energy consumption during production can be greatly reduced. In addition, the normalizing temperature is low and the holding time is short, which can also reduce the thickness of the iron oxide scale on the surface of the steel plate before the acid washing process, thus improving the acid washing efficiency and improving the surface quality and yield of the final non-oriented silicon steel.

The detailed descriptions listed above are merely specific illustrations of feasible embodiments of the present application, and the protection scope of the present application is not limited thereto. Equivalent embodiments or changes can be made without departing from the technical spirit of the present application, which are all embraced in the protection scope of the present application.

The technical solution of the present disclosure will be further described with reference to 6 examples of the present application below. Definitely, these embodiments are only some, rather than all of the variable embodiments included in the present application.

Examples 1 to 6 respectively provide a non-oriented silicon steel, having a chemical composition as shown in Table 1, in percentages by weight. Moreover, the non-oriented silicon steel of each example is a steel plate with a thickness as shown in Table 1.

TABLE 1

| | Chemical composition in percentages by weight (%) | | | | | | | | | | | | | | Thickness |
|---|---|---|---|---|---|---|---|---|---|---|---|---|---|---|---|
| | C | S | Si | Mr | P | Sn | Nb | V | Ti | Cr | Ni | Cu | Al | N | (mm) |
| Example | 0.0015 | 0.0011 | 3.05 | 0.65 | 0.012 | 0.034 | 0.002 | 0.002 | 0.003 | 0.03 | 0.01 | 0.02 | 0.88 | 0.0018 | 0.35 |
| 1 | | | | | | | | | | | | | | | |
| Example | 0.0015 | 0.0011 | 3.05 | 0.65 | 0.012 | 0.034 | 0.002 | 0.002 | 0.003 | 0.03 | 0.01 | 0.02 | 0.88 | 0.0018 | 0.30 |
| 2 | | | | | | | | | | | | | | | |
| Example | 0.0015 | 0.0011 | 3.05 | 0.65 | 0.012 | 0.034 | 0.002 | 0.002 | 0.003 | 0.03 | 0.01 | 0.02 | 0.88 | 0.0018 | 0.25 |
| 3 | | | | | | | | | | | | | | | |
| Example | 0.0018 | 0.0014 | 3.11 | 0.59 | 0.011 | 0.036 | 0.002 | 0.002 | 0.002 | 0.02 | 0.02 | 0.02 | 0.78 | 0.0031 | 0.35 |
| 4 | | | | | | | | | | | | | | | |
| Example | 0.0018 | 0.0014 | 3.11 | 0.59 | 0.011 | 0.036 | 0.002 | 0.002 | 0.002 | 0.02 | 0.02 | 0.02 | 0.78 | 0.0031 | 0.30 |
| 5 | | | | | | | | | | | | | | | |
| Example | 0.0018 | 0.0014 | 3.11 | 0.59 | 0.011 | 0.036 | 0.002 | 0.002 | 0.002 | 0.02 | 0.02 | 0.02 | 0.78 | 0.0031 | 0.25 |
| 6 | | | | | | | | | | | | | | | |

Non-oriented silicon steel of Examples 1-6 are sampled and tested. The tests include the following: (1) Metallographic test: The measured recrystallized grain sizes are shown in Table 2. (2) Mechanical performance test: The measured yield strength and tensile strength are shown in Table 2 respectively. (3) Magnetic performance test: the measured iron loss P_{1.0/400} and magnetic induction intensity 1B₅₀₀₀ are shown in Table 2 respectively.

TABLE 2

| | | | | | Magnetic |
|---|---|---|---|---|---|
| | Recrystallized | Yield | Tensile | Iron loss | induction |
| | grain | strength | strength | P_{1.0/400} | intensity |
| | size (μm) | (MPa) | (MPa) | (W/kg) | B₅₀₀₀ (T) |
| Example 1 | 62 | 483 | 595 | 18.1 | 1.681 |
| Example 2 | 65 | 485 | 584 | 16.8 | 1.677 |
| Example 3 | 58 | 505 | 596 | 15.7 | 1.673 |
| Example 4 | 65 | 478 | 579 | 17.9 | 1.683 |
| Example 5 | 71 | 486 | 586 | 16.6 | 1.678 |
| Example 6 | 68 | 482 | 582 | 15.6 | 1.673 |

The production method of non-oriented silicon steel in Examples 1 to 6 are as follows:
(1) Molten iron is refined into molten steel with a chemical composition shown in Table 1, and no alloying materials of Cu, Cr, Ni, Nb, V, and Ti are added during steel smelting. Then the refined molten steel is formed into a continuously casted billet with a thickness of 220 mm by a continuous casting process, where the chemical composition of the continuously casted billet is also shown in Table 1.
(2) The continuously casted billet in step 1 is heated in a heating furnace, where the heating temperature and holding time are shown in Table 3. Then, rough rolling, finish rolling, and cooling are performed sequentially, to obtain a hot-rolled coiled plate. The thickness of the intermediate billet obtained by rough rolling, the rolling start temperature and rolling end temperature during the finish rolling process, the total rolling reduction rate, the thickness of the hot-rolled plate and the coiling temperature during coiling are shown in Table 3.

TABLE 3

| | | | | | | | Thickness | |
|---|---|---|---|---|---|---|---|---|
| | | | | Finish | | Total | of hot- | |
| | Heating | Holding | Thickness of | rolling start | Rolling end | rolling | rolled | Coiling |
| | temperature | time | intermediate | temperature | temperature | reduction | plate | temperature |
| | (° C.) | (min) | billet (mm) | (° C.) | (° C.) | rate (%) | (mm) | (° C.) |
| Example | 1095 | 165 | 40 | 955 | 848 | 94.25 | 2.30 | 625 |
| 1 | | | | | | | | |
| Example | 1105 | 166 | 37.5 | 950 | 836 | 94.26 | 2.15 | 620 |
| 2 | | | | | | | | |
| Example | 1089 | 164 | 35 | 953 | 828 | 94.29 | 2.00 | 618 |
| 3 | | | | | | | | |
| Example | 1094 | 173 | 40 | 945 | 845 | 94.25 | 2.30 | 632 |
| 4 | | | | | | | | |
| Example | 1105 | 176 | 37.5 | 948 | 839 | 94.26 | 2.15 | 628 |
| 5 | | | | | | | | |
| Example | 1100 | 175 | 35 | 939 | 830 | 94.29 | 2.00 | 615 |
| 6 | | | | | | | | |

(3) The hot-rolled plate obtained in step 2 is normalized under pure and dry N₂ atmosphere. Constant-speed production is employed during the normalizing process. The normalizing temperature, and holding time are shown in Table 4.

After the normalizing, metallographic test is performed on the steel plate of each example. The area proportion of non-recrystallized structure and the recrystallized grain size measured are shown in Table 4. The area proportion of non-recrystallized structure is the proportion of the area of non-recrystallized structure to the total area of the sampled section of the steel plate.

TABLE 4

| | | | Area propor- | Recrys- |
|---|---|---|---|---|
| | Normalizing | Normalizing | tion of non- | tallized |
| | temperature | time | recrystallized | grain |
| | (° C.) | (s) | structure | size (μm) |
| Example 1 | 852 | 192 | 10 | 40 |
| Example 2 | 848 | 192 | 10 | 42 |
| Example 3 | 853 | 192 | 10 | 45 |
| Example 4 | 856 | 192 | 15 | 45 |
| Example 5 | 850 | 192 | 15 | 43 |
| Example 6 | 852 | 192 | 15 | 40 |

(4) The steel plate obtained in step 3 is washed with an acid, and after the acid washing, single stand cold rolling is carried out directly without preheating. During the single stand cold rolling, R passes of rolling are carried out, and the total rolling reduction rate is 85.301. The rolling reduction rates of other passes except the last pass are not less than 30%. The thickness of the obtained steel plate is shown in Table 1, and the rolling reduction procedures of each pass are shown in Table 5.

TABLE 5

| | | 1 | 2 | 3 | 4 | 5 |
|---|---|---|---|---|---|---|
| Examples | Thickness at | 2.300 | 1.510 | 1.020 | 0.673 | 0.444 |
| 1 and 4 | inlet (mm) | | | | | |
| | Thickness at | 1.510 | 1.020 | 0.673 | 0.444 | 0.350 |
| | outlet (mm) | | | | | |
| | Rolling | 34.2 | 32.5 | 34.0 | 34.0 | 21.2 |
| | reduction | | | | | |
| | rate (%) | | | | | |
| Examples | Thickness at | 2.150 | 1.410 | 0.900 | 0.576 | 0.380 |
| 2 and 5 | inlet (mm) | | | | | |
| | Thickness at | 1.410 | 0.900 | 0.576 | 0.380 | 0.300 |
| | outlet (mm) | | | | | |
| | Rolling | 34.4 | 36.2 | 36.0 | 34.0 | 21.1 |
| | reduction | | | | | |
| | rate (%) | | | | | |
| Examples | Thickness at | 2.000 | 1.300 | 0.850 | 0.540 | 0.350 |
| 3 and 6 | inlet (mm) | | | | | |
| | Thickness at | 1.300 | 0.850 | 0.540 | 0.350 | 0.250 |
| | outlet (mm) | | | | | |
| | Rolling | 35.0 | 34.6 | 36.5 | 35.2 | 28.5 |
| | reduction | | | | | |
| | rate (%) | | | | | |

(5) The steel plate obtained in step 4 is annealed under a mixed atmosphere of H₂+N₂. Constant-speed production is employed during the annealing process. The annealing temperature, and holding time are shown in Table 6. After the annealing, the steel plate is subjected to cooling, coating, and finishing sequentially, the non-oriented silicon steel of each example is obtained.

TABLE 6

| | Annealing | Annealing |
|---|---|---|
| | temperature (° C.) | holding time (s) |
| Example 1 | 970 | 43 |
| Example 2 | 972 | 43 |
| Example 3 | 975 | 43 |
| Example 4 | 968 | 43 |
| Example 5 | 972 | 43 |
| Example 6 | 965 | 43 |

It can be seen from the above Examples 1-6 that the non-oriented silicon steel according to one of the embodiments of the present application not only has excellent magnetic performances, but also has high strength, low alloying cost, low production difficulty, and low production cost, and can meet the requirement for use in the driving motor of new energy vehicles.

1. A method for producing a non-oriented silicon steel for driving motors of new energy vehicles, comprising: steel smelting, continuous casting, hot rolling, normalizing, acid washing, single stand cold rolling without pre-heating, annealing, cooling, coating, and finishing sequentially, to produce a non-oriented silicon steel with an arbitrary thickness in the range of 0.25 mm-0.35 mm, wherein
in the continuous casting procedure, the continuously casted billet obtained has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, C+S+N≤0.007%, Mn/S≥380, and Al/N≥200, with the balance being Fe and inevitable impurities;
in the hot rolling procedure, the continuously casted billet obtained after the continuous casting procedure is subjected to heating, rough rolling, finish rolling, and cooling sequentially, to obtain a hot-rolled coiled plate; during the finish rolling, the rolling start temperature is 950±20° C., the rolling end temperature is 840±20° C., and the total rolling reduction rate is 94-95%; during the coiling, the coiling temperature is 620±20° C.; and
in the normalizing procedure, the area proportion of the non-recrystallized structure is 5%-20%.

2. The method for producing a non-oriented silicon steel for driving motors of new energy vehicles of claim 1, wherein in the hot rolling procedure, the continuously casted billet obtained after the continuous casting procedure is heated to 1080° C.-1110° C. for 160 min-180 min.

3. The method for producing a non-oriented silicon steel for driving motors of new energy vehicles of claim 1, wherein in the normalizing procedure, the normalizing temperature is 840° C.-860° C. for 180 s-200 s.

4. The method for producing a non-oriented silicon steel for driving motors of new energy vehicles of claim 1, wherein in the annealing procedure, the annealing temperature is 960° C.-980° C. for 40 s−45 s.

5. The method for producing a non-oriented silicon steel for driving motors of new energy vehicles of claim 1, wherein in the single stand cold rolling procedure, multi-pass rolling is carried out, the total rolling reduction rate is 85±3%, and the rolling reduction rates of other passes except the last pass are not less than 30%.

6. The method for producing a non-oriented silicon steel for driving motors of new energy vehicles of claim 1, wherein in the hot rolling procedure, the continuously casted billet with a thickness of 220 mm is rough rolled into an intermediate billet with a thickness of 35 mm-40 mm, and then finish rolled into a hot-rolled plate with a thickness of 2.00 mm-2.30 mm.

7. The method for producing a non-oriented silicon steel for driving motors of new energy vehicles of claim 6, wherein the non-oriented silicon steel is a steel plate with a thickness of 0.25 mm, the intermediate billet has a thickness of 35 mm, and the hot-rolled plate has a thickness of 2.00 mm.

8. The method for producing a non-oriented silicon steel for driving motors of new energy vehicles of claim 1, wherein no alloying materials of Cu, Cr, Ni, Nb, V, Ti are added in the steel smelting procedure.

9. A non-oriented silicon steel for driving motors of new energy vehicles, wherein the non-oriented silicon steel has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, C+S+N≤0.007%, Mn/S≥380, and Al/N≥200, with the balance being Fe and inevitable impurities.

10. The non-oriented silicon steel of claim 9, wherein the recrystallized grain size of the non-oriented silicon steel is 50 μm-80 m.

11. The non-oriented silicon steel of claim 9, wherein the non-oriented silicon steel has a yield strength of ≥460 Mpa, a tensile strength of ≥550 Mpa, an iron loss P_{1.0/400} of ≤18.5 W/kg, and a magnetic induction strength B₅₀₀₀ of ≥1.67 T.

12. The non-oriented silicon steel of claim 11, wherein the non-oriented silicon steel is a steel plate with a thickness of 0.25 mm and an iron loss P₁0.0/400 of ≤17.5 W/kg.

13. The method for producing a non-oriented silicon steel for driving motors of new energy vehicles of claim 6, wherein the non-oriented silicon steel is a steel plate with a thickness of 0.30 mm, the intermediate billet has a thickness of 37.5 mm, and the hot-rolled plate has a thickness of 2.15 mm.

14. The method for producing a non-oriented silicon steel for driving motors of new energy vehicles of claim 6, wherein the non-oriented silicon steel is a steel plate with a thickness of 0.35 mm, the intermediate billet has a thickness of 40 mm, and the hot-rolled plate has a thickness of 2.30 mm.

15. The non-oriented silicon steel of claim 9, wherein the non-oriented silicon steel is a steel plate with a thickness of 0.30 mm and an iron loss P_{1.0/400} of ≤18.0 W/kg.

16. The non-oriented silicon steel of claim 9, wherein the non-oriented silicon steel is a steel plate with a thickness of 0.35 mm and an iron loss P_{1.0/400} of ≤18.5 W/kg.

17. A method for producing a non-oriented silicon steel for driving motors of new energy vehicles, comprising: sequentially, steel smelting, continuous casting, hot rolling, normalizing, acid washing, single stand cold rolling, annealing, cooling, coating, and finishing, to produce the non-oriented silicon steel;
in the hot rolling procedure, a continuously casted billet obtained after the continuous casting procedure is heated to 1080° C.-1110° C. for 160 min-180 min, followed by rough rolling, finish rolling, and cooling sequentially, to obtain a hot-rolled coiled plate. During the finish rolling, the rolling start temperature is 950±20° C., the rolling end temperature is 840±20° C., and the total rolling reduction rate is 94-95%. During the coiling, the coiling temperature is 620±20° C.;
in the normalizing procedure, the normalizing temperature is 840° C.-860° C. for 180s-200s;
in the annealing procedure, the annealing temperature is 960° C.-980° C. for 40 s−45 s;
the non-oriented silicon steel has a chemical composition including, in percentages by weight, Si: 2.95%-3.15%, Al: 0.75%-0.95%, Si+2Al: 4.6%-4.9%, Mn: 0.5%-0.7%, Sn: 0.03%-0.04%, Cu≤0.03%, Cr≤0.03%, Ni≤0.03%, Cr+Ni+Cu≤0.07%, Nb≤0.004%, V≤0.004%, Ti≤0.004%, Nb+V+Ti≤0.008%, C≤0.0025%, P≤0.015%, S≤0.0015%, N≤0.004%, and C+S+N≤0.007%, with the balance being Fe and inevitable impurities, where Mn/S≥380, and Al/N≥200; and
the recrystallized grain size of the non-oriented silicon steel is 50 μm-80 μm.

18. The method for producing a non-oriented silicon steel for driving motors of new energy vehicles of claim 17, wherein in the single stand cold rolling procedure, multi-pass rolling is carried out, the total rolling reduction rate is 85±3%, and the rolling reduction rates of other passes except the last pass are not less than 30%.

19. The method for producing a non-oriented silicon steel for driving motors of new energy vehicles of claim 17, wherein in the single stand cold rolling procedure, the steel plate after the acid washing procedure is directly rolled without preheating.

20. The method for producing a non-oriented silicon steel for driving motors of new energy vehicles of claim 17, wherein no alloying materials of Cu, Cr, Ni, Nb, V, Ti are added in the steel smelting procedure.
